(19) United States
(12) Patent Application Publication
(10) Pub. No.: US 2025/0133011 A1
(43) Pub. Date: Apr. 24, 2025

(54) ADVERTISING PUBLIC CLIENT ADDRESSES AT MULTIPLE GATEWAYS TO IMPROVE NETWORK PERFORMANCE

(71) Applicant: VIASAT, INC., Carlsbad, CA (US)

(72) Inventors: Aaron D. Brooks, Hudson, NH (US); Joel D. Martin, Duncanville, TX (US)

(73) Assignee: VIASAT, INC., Carlsbad, CA (US)

(21) Appl. No.: 18/817,082

(22) Filed: Aug. 27, 2024

Related U.S. Application Data
(63) Continuation of application No. PCT/US2022/018187, filed on Feb. 28, 2022.

(51) Int. Cl. H04L 45/24

(52) U.S. Cl. CPC H04L 45/24

(57) ABSTRACT

Described herein are systems and methods for improving network performance by advertising a single network address at diverse points (e.g., gateways) interfacing between two networks. The result of advertising a single network address at diverse points is that network traffic routing can select a shortest or lowest cost communication path that includes one of the points that advertised the single network address. Inline metadata and/or sideband signaling may be used to indicate to a network client which gateway received the traffic so that this gateway can be selected for subsequent network communication. The disclosed systems and methods assign the same network address to multiple nodes (e.g., client, switch, server, router, etc.), which is advertised to the network. Routing network traffic can use routing tables to find an optimal or superior communication path that includes one of the nodes that advertised the network address.

### CROSS-REFERENCE TO RELATED APPLICATIONS

This application is a continuation of International Patent Application No. PCT/US2022/018187, filed Feb. 28, 2022, and entitled “ADVERTISING PUBLIC CLIENT ADDRESSES AT MULTIPLE GATEWAYS TO IMPROVE NETWORK PERFORMANCE,” which is incorporated by reference herein in its entirety for all purposes.

### BACKGROUND

### Field

The present disclosure generally relates to routing network communication between two networks and, in particular, to advertising public client addresses at multiple gateways to efficiently route network traffic between entities on the two networks.

### Description of Related Art

Network clients can access network services using an access network or a private network that provides connectivity between the network clients and services. The access network typically includes gateways that control network traffic between an external network (e.g., the Internet) or a public network and the access network. These gateways can be used to direct traffic flows between the network clients and the network services. The location of these gateways in relation to the network clients and the network services can affect network performance.

### SUMMARY

According to a number of implementations, the present disclosure relates to a method of improving network performance by advertising a public network address of a network client at a plurality of gateways in a network. The method includes receiving client network traffic from a network client at a first gateway of a plurality of gateways, the client network traffic destined for a targeted network service, the network client having a private network address and a public network address. The method also includes routing the client network traffic to the targeted network service using the public network address of the network client as a source network address, the client network traffic routed from the network client to the targeted network service using a first communication path. The method also includes for each of the plurality of gateways in the network, advertising the public network address of the network client on the network. The method also includes selecting a gateway from the plurality of gateways for routing service network traffic from the targeted network service to the network client. The method also includes receiving service network traffic from the targeted network service at the selected gateway. The method also includes routing the service network traffic to the network client along a second communication path that includes the selected gateway.

In some embodiments, a median route along the portion of the second communication path between the targeted network service and the selected gateway has a cost that is less than or equal to a cost of the portion of the first communication path between the targeted network service and the first gateway. In some embodiments, the network comprises a satellite network. In some embodiments, the network comprises a hybrid access network. In some embodiments, the method further includes routing additional network traffic from the network client to the targeted network service using the second communication path.

In some embodiments, the method further includes receiving a signal indicating that the second gateway was selected for inclusion in the second communication path. In further embodiments, the method further includes routing packets from the network client to the targeted network service through the second gateway.

In some embodiments, each of the plurality of gateways is a hybrid aggregation gateway. In some embodiments, the first gateway is network closer to the network client than the second gateway. In some embodiments, the first gateway is selected based on a default gateway assigned to the network client.

According to a number of implementations, the present disclosure relates to a network environment includes customer premises equipment communicatively coupled to a network client, the network client having a private network address. The network environment includes a private network configured to provide network communication between the network client and a targeted network service on a public network. The network environment includes a plurality of gateway devices communicatively coupled to the private network and to the public network, the plurality of gateway devices configured to route network traffic between the private network and the public network, each of the plurality of gateway devices configured to advertise a public network address that corresponds to the network client. Network traffic is routed to the network client from the targeted network service through a selected gateway device of the plurality of gateway devices, the selected gateway device selected based at least in part on the selected gateway device providing a lowest-cost communication path between the targeted network service and the selected gateway.

In some embodiments, the private network address and the public network address are each an Internet Protocol (IP) address. In some embodiments, the private network comprises a satellite network. In some embodiments, the private network comprises a hybrid access network. In some embodiments, additional network traffic is routed from the network client to the targeted network service through the selected gateway.

In some embodiments, the network client is configured to receive a signal from the selected gateway indicating that the selected gateway was selected to provide a communication path between the network client and the targeted network service. In further embodiments, the network client is configured to route subsequent packets to the targeted network service through the selected gateway.

In some embodiments, each of the plurality of gateways is a hybrid aggregation gateway. In some embodiments, a first gateway device of the plurality of gateway devices is configured to provide a first communication path from the network client to the targeted network service, the first gateway device different from the selected gateway device. In further embodiments, the first gateway device is a default gateway assigned to the network client.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a diagram of an example network environment with a plurality of gateways providing connectivity between a private network and a public network.

FIG. 2 illustrates a diagram of an example hybrid network environment.

FIGS. 3A, 3B, and 3C illustrate an example of a procedure for advertising a public network address at multiple gateways to enable dynamic selection of a low-cost communication path.

FIGS. 4A, 4B, and 4C illustrate another example network environment to illustrate additional examples of the disclosed procedure for advertising network addresses to efficiently route network traffic.

FIGS. 5A, 5B, and 5C illustrate another example network environment to illustrate additional examples of the disclosed procedure for advertising network addresses to efficiently route network traffic in a hybrid access network.

FIG. 6 illustrates an example method of improving network performance by advertising a public network address of a network client at multiple gateways in a network.

### DETAILED DESCRIPTION OF SOME EMBODIMENTS

The headings provided herein, if any, are for convenience only and do not necessarily affect the scope or meaning of the claimed embodiments.

### Overview

A network environment can include devices and systems that enable communication between two computer networks. In certain network environments, a first node in a first computer network can communicate with a second node in a second computer network by traversing a gateway that joins the first computer network to the second computer network. A first communication path is the communication path between the first node and the gateway and a second communication path is the communication path between the second node and the gateway. The end-to-end communication path (e.g., between the first node and the second node) includes the first communication path and the second communication path. The performance of the end-to-end communication path in terms of latency, jitter, and packet loss is proportionately related to the number of network elements along the end-to-end communication path and the cumulative physical distance across the end-to-end communication path.

As a general example, a network environment can include a private network with one or more network clients and a public network with one or more network services. A gateway can connect the private network to the public network. In this example, the private network is the first computer network with an individual network client being the first node in the first computer network. Also in this example, the public network is the second computer network with an individual network service being the second node in the second computer network. The first communication path includes the path between the first node (a network client) and the gateway over the first computer network (private network) and the second communication path includes the path between the gateway and the second node (a network service) over the second computer network (public network).

As a more particular example, a network environment can include a hybrid access network. A hybrid access network is an access network that utilizes different network technologies and/or topologies, such as satellite and terrestrial components. The hybrid access network can connect network clients to network services using hybrid aggregation gateways (HAGs), or gateway devices that aggregate and direct network traffic across the different networks making up the hybrid access network. In this example, the hybrid access network is the first computer network with customer premises equipment (CPE) being the first node in the first computer network. Also in this example, an external network (e.g., the Internet) is the second computer network with a network service being the second node in the second computer network, with the HAG acting as the gateway. The first communication path includes the path between the first node (CPE) and the gateway (HAG) over the first computer network (hybrid access network) and the second communication path includes the path between the gateway (HAG) and the second node (network service) over the second computer network (Internet).

Directing network traffic in such network environments typically includes receiving network client traffic from a network client at the gateway and using a public network address (e.g., IP address) as the source network address upon forwarding the network traffic to the destination network service. To operate transparently in a private network (e.g., a hybrid access network) with a single public network address, network client traffic typically traverses a gateway to which the public network address has been assigned, before exiting to the public network (e.g., the Internet). Return network traffic typically then returns through the same gateway which has been assigned the public network address corresponding to the network client. The gateway knows the private network address of the network client and forwards received network traffic to the network client over the private network.

For any given network client and network service, there is an ideal route that minimizes the network traversal between the network client and the network service. For some networks (e.g., a hybrid access network) and gateways (e.g., a HAG), the gateway can be positioned anywhere between the network client and the network service on the ideal path without introducing significant or appreciable network latency or jitter (beyond the processing required to traverse the gateway). Increases in the network distance and/or geographic distance between the gateway and the ideal route adversely affect the performance of this network path, particularly in terms of latency and jitter.

This increase in network and/or geographic distance may be unavoidable in most networks because a network client typically communicates with more than one network service, resulting in a variety of communication paths. Where a network client communicates with multiple different network services at different points across the network, deviation from the ideal path increases for some or all the corresponding communication paths. An optimal placement of the gateway would then be a point determined by an average deviation from the ideal path. This optimization could be weighted by cost (e.g., according to some metric) and/or usage factors. A typical result of this optimization would be to position the gateway as close to the network client as possible, where proximity is related to network proximity and/or geographic proximity.

However, there are typically multiple network clients in a network environment. Cost and other logistical constraints make it desirable to have a gateway service multiple clients rather than having dedicated gateways for individual network clients. When a gateway supports multiple network clients that are at diverse locations on the network, the optimal placement of the gateway in relation to the network clients and network services deviates from the ideal path between individual network clients and individual network services. The result may be relatively large deviations from the ideal communication path between individual network clients and individual network services, negatively impacting network performance (e.g., by increasing latency, jitter, packet loss, etc.).

Certain approaches can be used to mitigate these negative effects on network performance. For example, a gateway can advertise a single network address at a single point in the network. The result is that network traffic destined for the single network address is routed through the gateway advertising the network address, regardless of whether there is a better communication path (e.g., through a different gateway). As another example, gateways can advertise multiple addresses, singly advertised at diverse points in the network. The result is that network traffic destined for any of the multiple addresses is directed to the particular gateway that advertised one of the addresses, regardless of whether there is a better communication path (e.g., through a different gateway). However, these approaches may not mitigate adverse effects to network performance to a satisfactory degree.

Accordingly, to address these and other issues, described herein are systems and methods for improving network performance by advertising a single network address at diverse points interfacing between two networks. A plurality of gateways at diverse points between the two networks can advertise a single address that corresponds to a particular network client. The result of advertising a single network address at diverse points is that routing network traffic from the network service back to the network client can select a shortest or lowest cost (e.g., according to a routing metric) communication path that includes one of the gateways that advertised the single network address. In some embodiments, because the shortest or lowest cost communication path is determined with respect to routing traffic within the public network to the gateway, the result of routing network traffic to a particular gateway may result, in some instances, in an increase in length or cost in routing traffic within the private network from the selected gateway to the network client. However, median routing cases are typically an improvement rather than a degradation. In certain instances, the return communication path from the network service to the network client may be different from the original communication path. In some embodiments, inline metadata and/or sideband signaling can be used to indicate to the network client which gateway received the return network traffic so that the network client can select that gateway for subsequent network communication. In some embodiments, the network client can use routing tables and/or logic to select the gateway to be used to route traffic to the public network and the signaling from the selected gateway can be used by the network client to update the routing tables and/or logic.

The disclosed systems and methods may be particularly advantageous for presence mapping from a private network to a public network. In particular, for an individual network client in a private network, a plurality of gateways can advertise a public network address that corresponds to the individual network client. Each of the plurality of gateways that advertises the public network address knows the corresponding private network address of the individual network client. Thus, network traffic routed to a gateway using the public network address is then routed to the appropriate network client using the corresponding private network address. This presence mapping allows for network traffic from a network service on a public network to be routed to the network client on the private network along an efficient or advantageous path, such as a shortest or lowest cost path (e.g., according to a routing metric). This efficient routing depends at least in part on routing the network traffic through a particular gateway (selected from the plurality of gateways advertising the public network address) that provides a superior communication path from the network service on the public network to the gateway advertising the public network address of the network client on the private network. Thus, the public network, in routing traffic back to the network client, can select a gateway from the multiple gateways that is advertising the appropriate address for the network client, the selected gateway providing an efficient, beneficial, superior, optimal, lowest-cost, and/or shortest path within the public network to the selected gateway.

By extension, the disclosed devices and methods can accomplish a similar presence mapping from a private network with a plurality of network clients to a public network with a plurality of network services. For each network client on the private network, a plurality of gateways can advertise a public network address corresponding to a particular network client to improve the routing of network traffic between a variety of network services on a public network and the network clients on the private network.

In some embodiments, a single public network address advertised by the plurality of gateways can correspond to a plurality of network clients. For example, network address translation (NAT) and/or port address translation (PAT) can be employed to enable a single advertised public network address to be used for multiple network clients. The disclosed systems and methods can manage presence mapping between two networks on the basis of traffic flows. In certain implementations, individual traffic flows associated with individual network clients can be mapped to a port or a range of ports of the single advertised public network address. As a result, network traffic destined for a particular network client can be routed efficiently using the single advertised public network address, as described herein, based at least in part on the port associated with the network traffic. Furthermore, this technique can be employed using any variety of port management and/or port mappings to route individual traffic flows to the correct network client using a single public network address for multiple network clients. Thus, each advertised public network address disclosed herein can be used for a single network client or for a plurality of network clients. In addition, each gateway can advertise one or more public network addresses for the network clients serviced by the gateway.

Advertising a particular network address at multiple points in the network can be referred to as anycast or IP anycast, which represents a one-to-nearest-of-many network routing method. This can be differentiated from unicast (a one-to-one network routing method) and multicast (a one-to-many network routing method). Anycast is a feature in networks that allows a range of network addresses to be advertised from multiple points in the network. The effect of this multiple advertisement is that network routes to the advertised network addresses are typically routed to the nearest or generally lowest cost (e.g., for some routing metric) advertisement point.

The disclosed systems and methods assign the same network address to multiple nodes (e.g., client, switch, server, router, etc.), which is advertised to the network. Network traffic can be routed using routing tables to find an optimal or superior communication path that includes one of the nodes that advertised the network address.

Typical usage of anycast addresses is to provide localized services. Because there is no guarantee of stable routing, anycast is typically reserved for stateless services such as DNS. However, the disclosed systems and methods use anycast to advertise public network addresses for network clients, which is different from the typical usage case of advertising network addresses for network services. An advantage of the disclosed systems and methods is that gateways can be placed in various places in the network and/or geographically and optimal or superior routing, given the placement of the gateways, can be achieved by dynamically determining preferred or improved communication paths. This is accomplished by having multiple gateways advertise the same network address corresponding to a public network address of a network client and relying on routing tables and routing methods to determine a shortest or lowest cost path within the public network to a gateway that advertised the network address.

To handle multiple gateways and multiple network clients, the disclosed systems and methods use anycast address blocks as public client network address ranges. The addresses are advertised at all gateway points-of-presence that can service entry and exit to the public or external network (e.g., the Internet). A result is that a network client is not just served by a single gateway, but rather all gateways advertising the public network address of that network client. This can advantageously increase redundancy, decrease network hops, and decrease latency for network traffic to the network client, thereby improving network performance.

### Example Network Environments

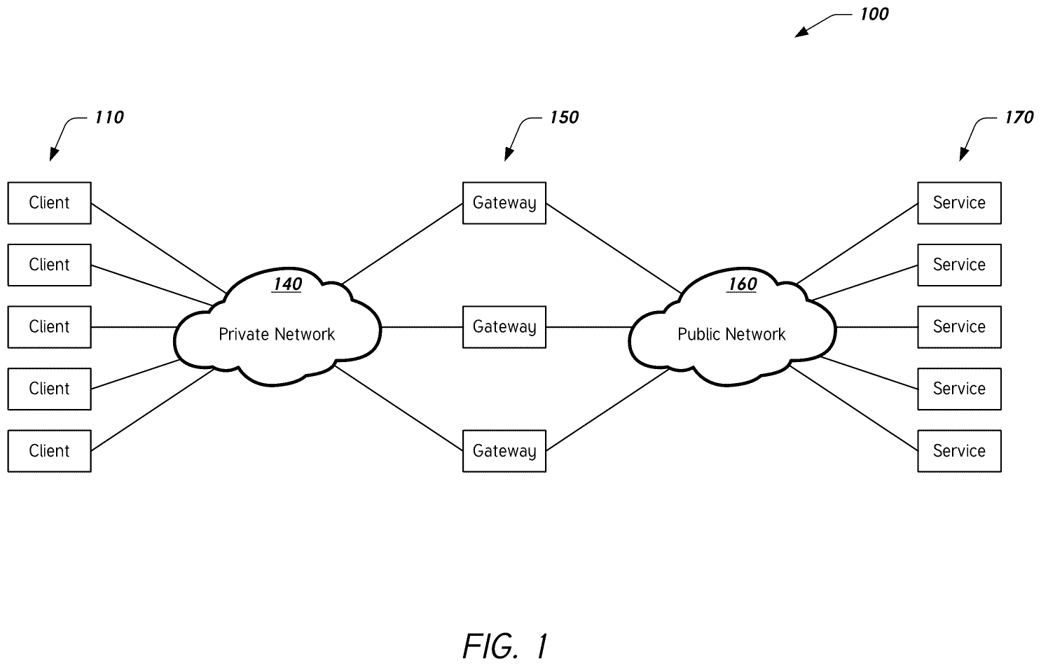

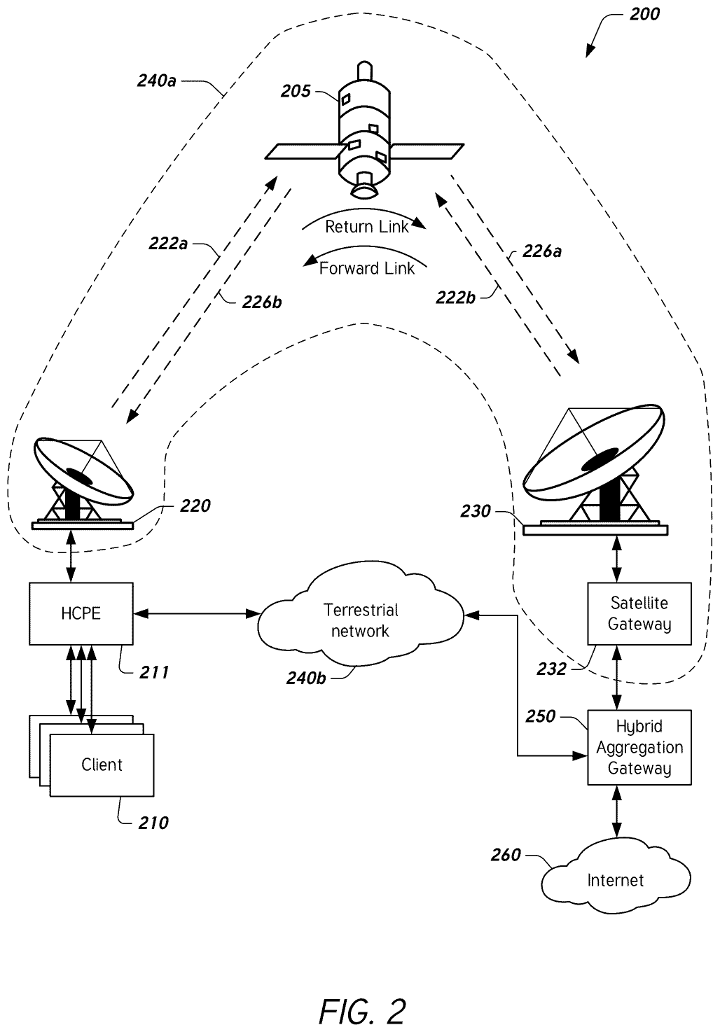

FIG. 1 illustrates a diagram of an example network environment 100. The network environment 100 includes a private network 140 and a public network 160. The private network 140 includes a plurality of network clients 110 and the public network 160 includes a plurality of network services 170. The plurality of gateways 150 provide connectivity between the private network 140 and the public network 160. Thus, the plurality of gateways 150 is configured to direct network traffic (e.g., to provide communication paths) between network clients 110 and network services 170. The private network 140 can be any suitable network, such as a satellite network, a terrestrial network, a hybrid network as described herein with reference to FIG. 2, a virtual private network (VPN), an access network (e.g., provided by an Internet Service Provider (ISP)), etc. As discussed herein, the gateways 150 interface between the private network 140 and the public network 160 and provide presence mapping by advertising blocks of public addresses corresponding to the plurality of network clients 110.

The plurality of gateways 150 provide network communication between the private network 140 and the public network 160. The network clients 110 can access the private network 140 through customer premises equipment (CPE), for example. The network services 170 can be any service, software functionality, website, or the like provided to a network client over a network. The public network 160 can be any suitable network external to the private network 140, and may include the Internet, for example.

The network clients 110 (or CPEs) can have private network addresses known to the gateways 150 as part of the private network 140. The network clients 110 can also have public network addresses used by the gateways 150 as a source network address when routing network traffic to the network services 170. The network services 170 can use the public network address of a network client 110 to route response network traffic to a network client 110. As described herein, the gateways 150 can each advertise the public network addresses of the network clients 110 as the network addresses of the gateways 150. Consequently, the public network 160 can determine which gateway 150 represents a preferred or low-cost communication path within the public network 160 back to the network client 110 and can direct network traffic to that particular gateway. In this way, anycast can be used to map between the public network 160 and the private network 140 to find superior, optimal, low cost, and/or short communication paths within the public network. In addition, as described herein, a single advertised public network address can be used by a gateway for a plurality of network clients by managing port mappings to traffic flows.

The location of the gateways 150 relative to the network clients 110 and/or the network services 170 can affect network performance. In some embodiments, where the private network 140 is a terrestrial access network, the breakout location of a gateway 150 can be relatively close to a network client 110. In some embodiments, where the private network 140 is a satellite access network, the breakout location of a gateway 150 can be placed arbitrarily relative to a network client 110. However, the resulting geographical distribution of gateways 150 and network clients 110 can adversely affect network performance by deviating from ideal communication paths.

An approach for improving network performance may be to minimize a distance between a network client and a gateway. However, there is typically a limited number of points-of-presence that can be projected by an ISP. The fewer gateways 150 available, the more probable the communication path will be inefficiently long or distant or the more it will deviate from the ideal communication path. In addition, because network clients 110 typically access a variety of network services 170, it is difficult or impracticable to predict a direction or path of all network traffic. Consequently, it is difficult or impracticable to predict an optimal placement of individual gateways 150.

To improve network performance, the gateways 150 are configured to advertise blocks of network addresses corresponding to public network addresses of network clients 110. The public network 160 sees these advertised addresses and determines a low cost or short communication path by selecting one of the gateways 150 according to routing rules or tables. The result is an advertisement of public network addresses in multiple locations across the network, which allows the public network 160 to pick the lowest cost or shortest communication path for network traffic within the public network 160. This also enables dynamic routing and makes the network services 170 appear closer to the network clients 110.

For traditional stateful services (such as establishing a network connection between a network client and a network service), the multiple points of advertisement for anycast can be challenging due at least in part to the flow of network traffic being dynamically routed to any of those dispersed points. The disclosed advertisement of public addresses, however, preserves the end-to-end stateful application communication due at least in part to using the advertised public addresses only as intermediate points for routing across the private and public networks (or internal and external networks). The advertised public addresses can be used to identify an efficient communication path to provide access back from a network service. This effectively represents a way of efficiently mapping a private network topology onto a physical network topology.

The gateways 150 can be distributed so that there are multiple points that can handle network client traffic. Each of the gateways 150 knows the private addresses of each of the network clients 110. In addition, each of the gateways 150 owns a block of public network addresses with individual public network addresses corresponding to individual network clients 110 that each have a private network address known to the gateways 150. In this way, the presence of network clients 110 can be represented by the public network addresses advertised by the gateways 150. Because each of the gateways 150 advertises the same public network addresses, the public network 160 sees multiple routes to the same network address. With these options available to the public network 160, the public network 160 is able to select a low-cost and/or short communication path to a particular gateway 150. In some embodiments, the gateway 150 providing the superior or optimal communication path changes over time so that the advertising and dynamic routing procedures described herein can be repeated to achieve dynamic and low-cost network traffic routing. In some embodiments, the routes to the public network addresses are advertised on the public network 160 before-hand. That way the public network 160 can route network traffic along the shortest and/or lowest-cost communication path to the gateways 150 that advertised the public network addresses.

FIG. 2 illustrates a diagram of an example hybrid network environment 200. The hybrid network environment 200 is similar to the network environment 100 described herein with reference to FIG. 1 wherein the private network 140 comprises a hybrid network configuration. The hybrid network configuration includes a satellite network 240a and a terrestrial network 240b that work together to communicatively couple a hybrid customer premises equipment (HCPE) 211 and a hybrid aggregation gateway (HAG) 250 to one another and to a public network (such as the Internet 260). The satellite network 240a typically has a higher latency and bandwidth than the terrestrial network 240b. The combination of the satellite network 240a and the terrestrial network 240b forms a hybrid access network (HAN), which is a network architecture that allows a network client to employ two or more network links, typically of different technologies or characteristics, to access network services on another network (e.g., the Internet).

The hybrid network environment 200 may utilize various network architectures that include space and ground segments. For example, the space segment may include one or more satellites, while the ground segment may include one or more satellite user terminals, gateway terminals, network operations centers (NOCs), satellite and gateway terminal command centers, and/or the like. Some of these elements are not shown in the figure for clarity. In some embodiments, the satellite network 240a includes one or more satellites in a geosynchronous orbit. In various embodiments, the terrestrial network 240b may be any type of network and may include, for example, the Internet, an IP network, an intranet, a wide-area network (WAN), a local-area network (LAN), a virtual private network (VPN), a public switched telephone network (PSTN), a public land mobile network, a digital subscriber line (DSL), a cellular network, wireless local area network (WLAN) access point (AP) connected to DSL, or any combination of these.

The HCPE 211 can include a router or other such device (e.g., a telephone, modem, computer, set-top box, and the like) and can be configured to route network data to a plurality of network clients 210. The network clients 210 may be a person, device, or software entity accessing one or more services on a network. The network clients 210 can be configured to access network services through the public network 260. Network services may include software functionality or resources, presented for access over a network.

The HOPE 211 is configured to route data received from the network clients 210 to the satellite network 240a (via a customer satellite transceiver 220) and/or to the terrestrial network 240b. The satellite network 240a includes a forward link for sending information from the HAG 250 to the HCPE 211, and a return link for sending information from the HCPE 211 to the HAG 250. The forward link includes a transmission path from the HAG 250 through a satellite gateway 232 and its gateway satellite transceiver 230, through a satellite 205 via a satellite uplink channel 222b, to the customer satellite transceiver 220 via a satellite downlink channel 226b, and to the HCPE 211. The return link includes a transmission path from the customer satellite transceiver 220, to the satellite 205 via the satellite uplink channel 222a, to the gateway satellite transceiver 230 via the satellite downlink channel 226a, through the satellite gateway 232, and to the HAG 250. Each transmission channel may utilize multiple satellites and transceivers.

Both the HCPE 211 and the HAG 250 are configured to interface with both the satellite network 240a and the terrestrial network 240b, collectively forming the HAN. The HCPE 211 is configured to manage communication between the network clients 210 and the HAN whereas the HAG 250 is configured to manage communication between the HAN and the public network 260 (e.g., to and from network services).

The HAG 250 may be referred to as a hub or ground station. In certain embodiments, the HAG 250 is configured or designed to service forward uplink signals 222b to a satellite 205, and to return downlink signals 226a from the satellite 205. The HAG 250 also services traffic across the terrestrial network 240b. The HAG 250 is also configured to advertise a public network address of a network client 210 in conjunction with other HAGs advertising the same public network address, as described herein. Furthermore, the HAGs 250 are configured to advertise public network addresses corresponding to the network clients 210.

The HAG 250 may also provide an interface between the Internet 260 and the satellite network 240a and/or the terrestrial network 240b. The HAG 250 may receive data and information from the Internet 260 that is directed to the HCPE 211. The satellite gateway 232 and/or the HAG 250 may format the data and information for delivery to the HCPE 211 via the satellite network 240a. The HAG 250 may also receive signals carrying data and information from the satellite network 240a. This data and information may be transmitted by the HCPE 211 and directed to destination network services accessible via the Internet 260. The satellite gateway 232 and/or the HAG 250 may format this data and information for delivery via the Internet 260. The Internet 260 may connect the HAG 250 with other gateway routing devices that may be in communication with the satellite network 240a or with other satellite networks. In some embodiments, part or all of the HAG 250 and/or the satellite gateway 232 can be located in a virtual device residing in a public or private computing cloud.

The satellite 205 may be a geosynchronous satellite that is configured to receive and transmit signals. The satellite 205 may receive the forward uplink signals 222b from the gateway satellite transceiver 230 via the HAG 250 and transmit one or more corresponding forward downlink signals 226b to one or more user terminals (e.g., HCPE 211) via the customer satellite transceiver 220. The satellite 205 may also receive one or more return uplink signals 222a from one or more user terminals (e.g., HCPE 211) and transmit corresponding return downlink signals 226a to the HAG 250.

It should be understood that although a single HAG 250 and a single HCPE 211 are shown, the network environment 200 can include a plurality of HAGs and a plurality of HCPEs that are geographically distributed. The disclosed network environment 200 can be configured to have a plurality of HAGs advertise a public network address for an individual HCPE so that an optimal or superior communication path to a selected HAG 250 can be used to route return network traffic to the network client 210, as described in greater detail herein.

### Examples of Advertising a Public Network Address at Multiple Gateways

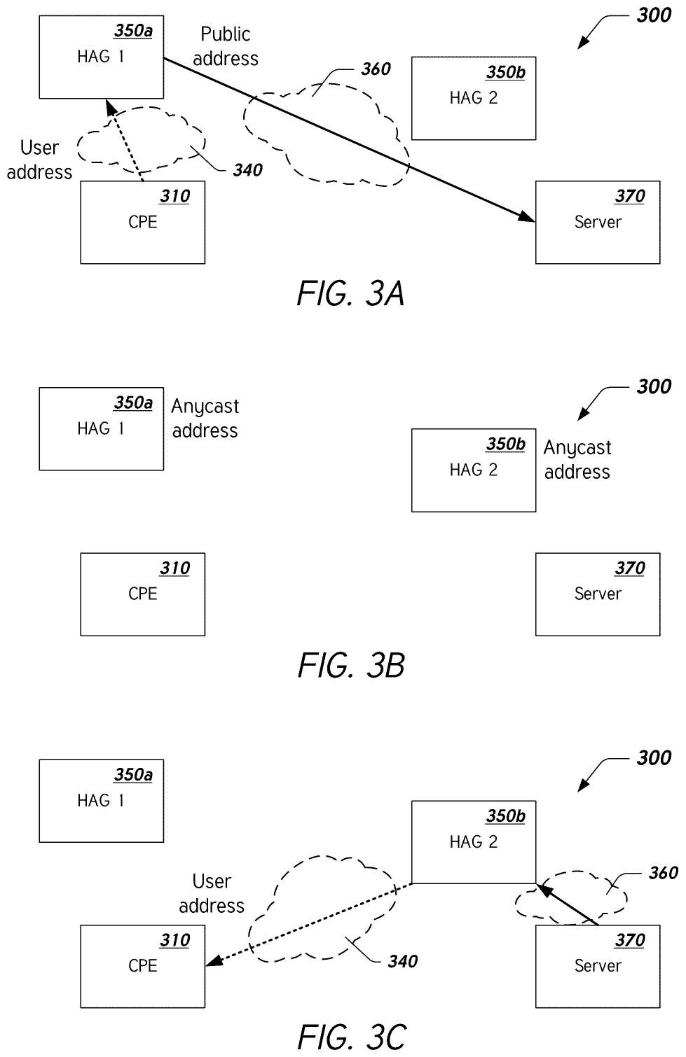

FIGS. 3A, 3B, and 3C illustrate an example of a procedure for advertising a public network address at multiple gateways to enable dynamic selection of a low-cost communication path. The procedure is performed in a network environment 300 that is similar to the network environments 100, 200 described herein with reference to FIGS. 1 and 2. The network environment 300 provides connectivity between a CPE 310 and a network server 370 by way of HAGs 350a, 350b. The CPE 310 is similar to the network clients described herein with reference to FIGS. 1 and 2. Similarly, the network server 370 is similar to the network services 170 described herein with reference to FIG. 1. The HAGs 350a, 350b are similar to the gateways 150 and the HAG 250 described herein with respect to FIGS. 1 and 2, respectively.

The network environment 300 provides network communications to the CPE 310 to enable communication with the network server 370. The network environment 300 includes a private network 340 and a public network 360 with the HAGs 350a, 350b interfacing between the two networks 340, 360. The private network 340 can be any suitable access network, such as the access networks 140, 240a, 240b described herein with reference to FIGS. 1 and 2. The public network 360 can be any suitable external network, such as the public network 160 or the Internet 260, as described herein with reference to FIGS. 1 and 2, respectively. As shown here, the private network 340 connects the CPE 310 to the public network 360 via the HAG 350a and/or the HAG 350b, enabling network communication with the network server 370.

FIGS. 3A-3C illustrate a typical network traffic flow employing the disclosed technologies. In the figures, the dotted line represents communication over the private network 340 (e.g., hybrid network, VPN, etc.) and the solid lines represent communication over the public network 360 (e.g., Internet).

Thus, a request from a network client (through the CPE 310) with a particular private network address (e.g., a user IP address) is sent to a first HAG 350a using the private network 340. The HAG 350a routes the request to the network server 370 over the public network 360 using a public network address (e.g., a public IP address) that is associated with the network client as a source address. The HAGs 350a, 350b advertise the same anycast network address (corresponding to the public network address used as the source address). The public network 360 selects a superior or optimal (e.g., a lowest-cost or shortest) communication path back to the HAG 350b. The HAG 350b forwards the network traffic to the network client using the private network address of the network client. In some embodiments, a routing table can be set up on the private network 340 so that outbound network traffic from the CPE 310 uses the same HAG 350b that is used for the inbound traffic from the network server 370. The disclosed technologies enable the network environment 300 to find superior or optimal paths within the public network 360 between a network server 370 and a HAG 350a, 350b. Although the disclosed technologies may result in individual routes over the public network 360 being degraded, the median end-to-end route (e.g., from the network server 370 to the CPE 310) is expected to improve (or at least not degrade).

FIG. 3A illustrates a network client initiating communication with a network server 370 by sending an outbound packet through the CPE 310. The private network 340 chooses a HAG 350a and a path to that HAG 350a according to a current routing policy. In some embodiments, the current routing policy can designate the HAG 350a as a default or home HAG. In certain instances, the default HAG can be a HAG that is geographically near and/or network near to the network client. The CPE 310 has a private network address (labeled “user address” in the figure) which is known to the HAG 350a.

The CPE 310 tunnels the packet to the HAG 350a via an overlay network. As used herein, an overlay network includes a logical network topology layered across another network, called the underlay network. Tunneling the packet can include encapsulating the packet by wrapping the partial or full packet contents of an overlaying level network in packets of an underlaying network, hiding the details of the higher-level network. A tunnel or network tunnel is an approach that allows overlay network traffic to be transported between points on the underlay network by means of packet encapsulation.

On receipt, the HAG 350a removes the encapsulation of the overlay network and sends the packet across the public network 360 to the target network server 370. The departing packet has the network client's public anycast network address (labeled “public address” in the figure) as the source address.

FIG. 3B illustrates the target network server 370 that received the packet generating a response. This response packet will be addressed to the public anycast network address assigned to the network client. Because the network client address, now the destination address of the packet, is advertised at many points across the network (labeled “anycast address” in the figure), local internet routing rules are configured to find a “lowest cost” route and to send the packet to what local routing logic considers the “nearest” or “lowest cost” HAG advertising the anycast address, effectively picking a HAG “nearest” to the target network server 370. Thus, the HAGs 350a, 350b advertise (e.g., using anycast) network addresses that are the public network addresses of clients behind their network.

FIG. 3C illustrates the return packet being routed back to the network client through the HAG 350b, which represents the shortest or lowest cost communication path back to the HAG 350b within the public network 360. The public network 360 uses the anycast network address (which corresponds to the public network address of the network client) to route the return packet to the HAG 350b. The packet is then routed over the private network 340 from the HAG 350b to the CPE 310 using the private network address (or “user address”) of the network client.

In some embodiments, the receiving HAG 350b can signal to indicate to the CPE 310 which HAG was selected by anycast routing to be the nearest gateway for the traffic flow between the network client and the target network server 370. The signal can be an in-band signal, e.g., using metadata in the encapsulated returning tunnel packet, or an out-of-band signal, e.g., using a separate packet. Subsequent packets can be forwarded by the CPE 310 not to the default HAG 350a but to the HAG 350b nearest to the target network server 370, e.g., as determined by the return route determined in FIG. 3C. The signal from the HAG 350b can be used by the CPE 310 to create a policy entry and/or update a routing rule or table. The CPE 310 can then directing subsequent packets (either specific to higher level protocol details or general based on the network address) to the HAG identified as closest to the target network server. In this manner, anycast address advertisement, internet routing behavior, and dynamic network policies can be used to route traffic flows that traverse a path of minimal or reduced deviation from an ideal communication path or an optimal communication path. In some embodiments, the communication path uses the same HAG for network traffic from the CPE 310 to the network server 370 and back to the CPE 310 from the network server 370.

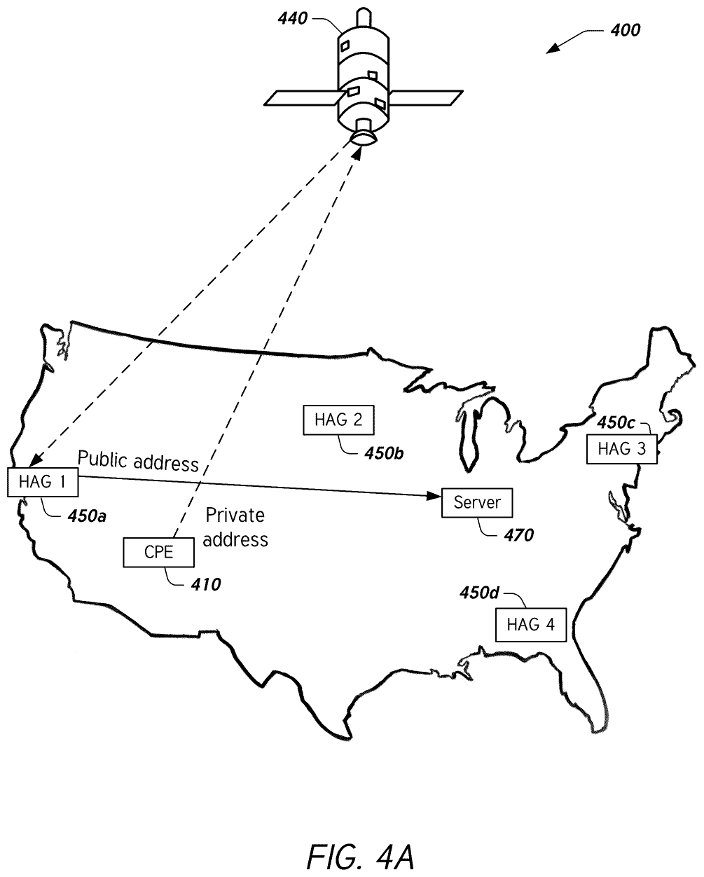

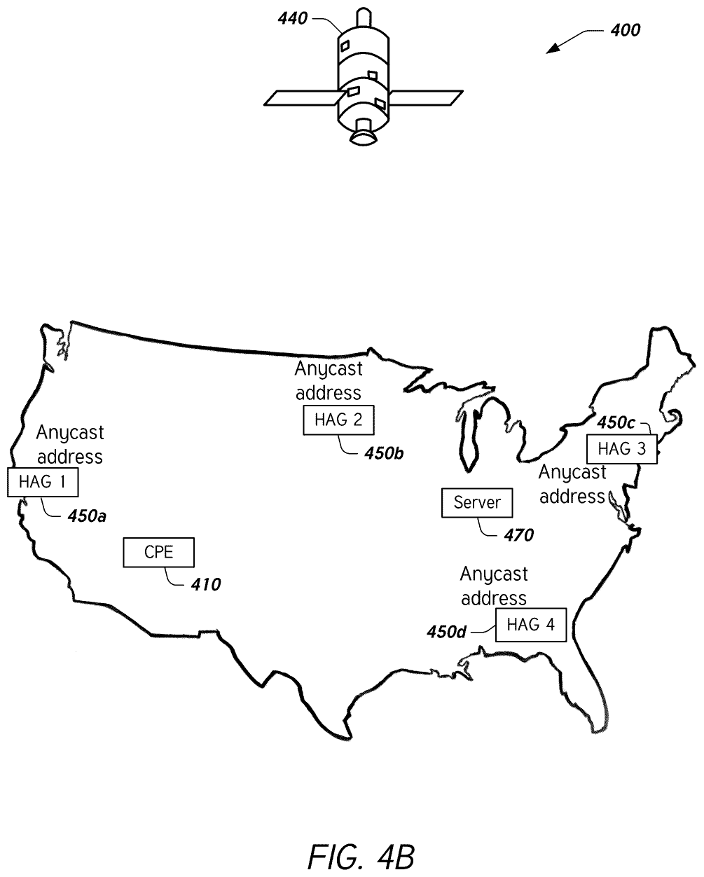

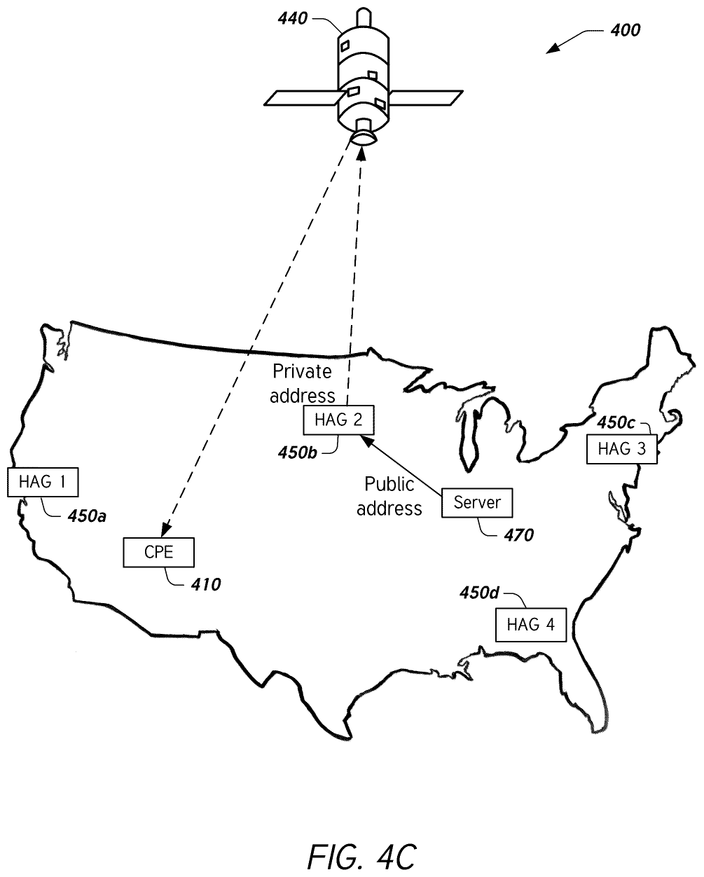

FIGS. 4A, 4B, and 4C illustrate another example network environment 400 to illustrate additional examples of the disclosed procedure for advertising IP anycast addresses to efficiently route network traffic. The procedure is performed in a network environment 400 that is similar to the network environments 100, 200, 300 described herein with reference to FIGS. 1-3. The network environment 400 provides connectivity between a CPE 410 and a network server 470 by way of HAGs 450a-450d. The CPE 410 is similar to the CPEs described herein with reference to FIGS. 2 and 3. Similarly, the network server 470 is similar to the network services 170 and the network server 370 described herein with reference to FIGS. 1 and 3, respectively. The HAGs 450a-450d are similar to the gateways 150, the HAG 250, and the HAGs 350a, 350b described herein with respect to FIGS. 1-3, respectively.

The network environment 400 provides network communications to the CPE 410 to enable communication with the network server 470 using a satellite network 440. The satellite network 440 is similar to the private networks 140, 240a described herein with reference to FIGS. 1 and 2.

FIGS. 4A-4C illustrate a typical network traffic flow employing the disclosed technologies. In the figures, the dashed line represents a private network (e.g., hybrid network, satellite network, VPN, ISP, etc.) that incorporates the satellite network 440 and the solid lines represent public networks (e.g., Internet).

The network environment 400 illustrates the disclosed process in a geographical setting using a satellite access network 440. FIG. 4A illustrates that, in such an environment, a request from a network client (through the CPE 410) is sent to a first HAG 450a via the satellite network 440 using a private network address (e.g., a user IP address). The first HAG 450a can be selected because it is physically the closest HAG to the CPE 410. In some embodiments, the first HAG 450a is a default HAG associated with the CPE 410. For example, the CPE 410 can direct network traffic to the first HAG 450a as a default, which may be updated or changed based on efficient routing determinations made using anycast address advertisement, as disclosed herein. In some embodiments, updates or changes to the HAG used by the network client can be based on signaling from a HAG selected using the anycast routing procedures disclosed herein. In other words, a HAG that has been selected using anycast routing procedures can signal the network client to indicate which HAG received the return network traffic. The first HAG 450a routes the request to the network server 470 over a public network using a public network address as a source address.

FIG. 4B illustrates that the HAGs 450a-450d advertise the same anycast network address (corresponding to the public network address used as the source address). Because the HAGs 450a-450d each advertise the same anycast network address corresponding to the network client, the public network sees multiple possible communication paths from the network server 470 back to the network client through the CPE 410. This enables the public network to determine a communication path that reduces or minimizes a routing cost (e.g., according to some routing metric) to the HAG.

FIG. 4C illustrates that the public network selects the lowest-cost communication path to the HAG 450b from the network server 470. The private network routes the network traffic from the second HAG 450b to the network client over the satellite network 440 using the private network address of the network client. As disclosed herein, reducing or minimizing the routing cost along the public network (between the network server 470 and the HAG 450b) may result in individual routes from the network server 470 to the CPE 410 to degrade, however, it is expected that the median route improves (or at least does not degrade) from the network server 470 to the CPE 410.

In some embodiments, a routing table can be set up to keep using the route determined during the initial communication exchange between the CPE 410 and the network server 470. This can be done, for example, using signaling from the HAG 450b to the CPE 410. In some embodiments, anycast network addresses can be used each time traffic is routed back to the network client due at least in part to the dynamic nature of networks such as the Internet. This enables the network environment 400 to find superior or optimal paths (e.g., low-cost paths or network-close paths) from a network server 470 to a HAG.

In some embodiments, Border Gateway Protocol (BGP) paths can be used to determine communication paths in the public network (e.g., the Internet). In such embodiments, BGP can be used at least in part to determine the geographically closest server. For example, network routing decisions can be handled dynamically by the public network (e.g., BGP) between the network server 470 and the HAGs 450a-450d.

In some instances, when the public network seeks to route traffic from the network server 470 to the network client, it receives various announced routes and selects the shortest path. This allows the public network to choose a near optimal or near shortest path every time. In the event of a network node failure, the next shortest route is determined, and network traffic is redirected without having to change the network address of the gateway or HAG.

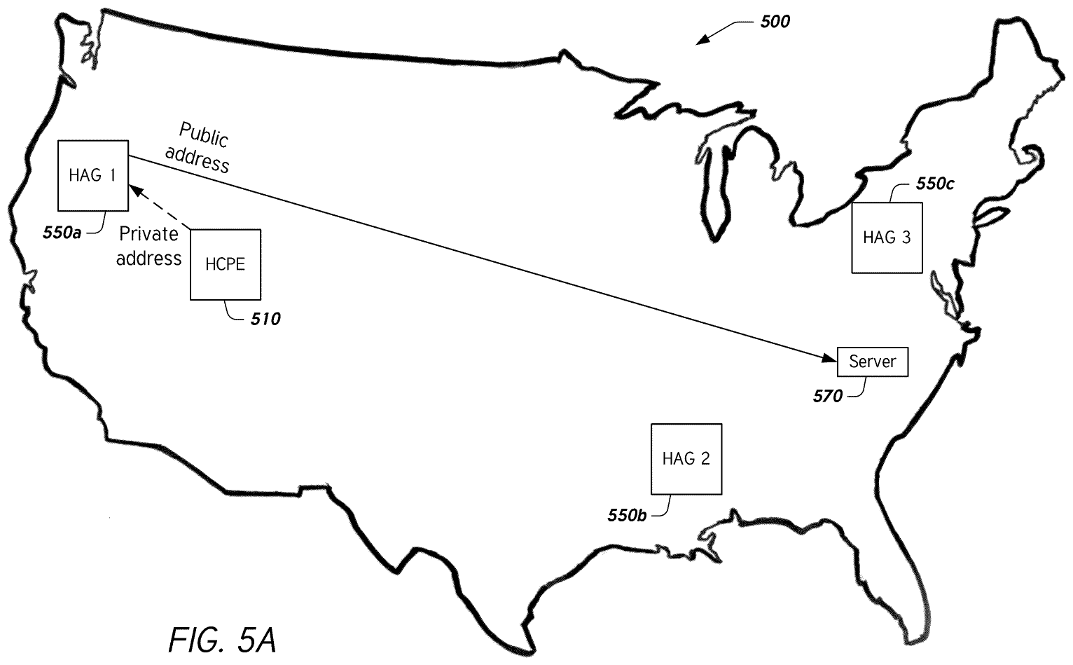

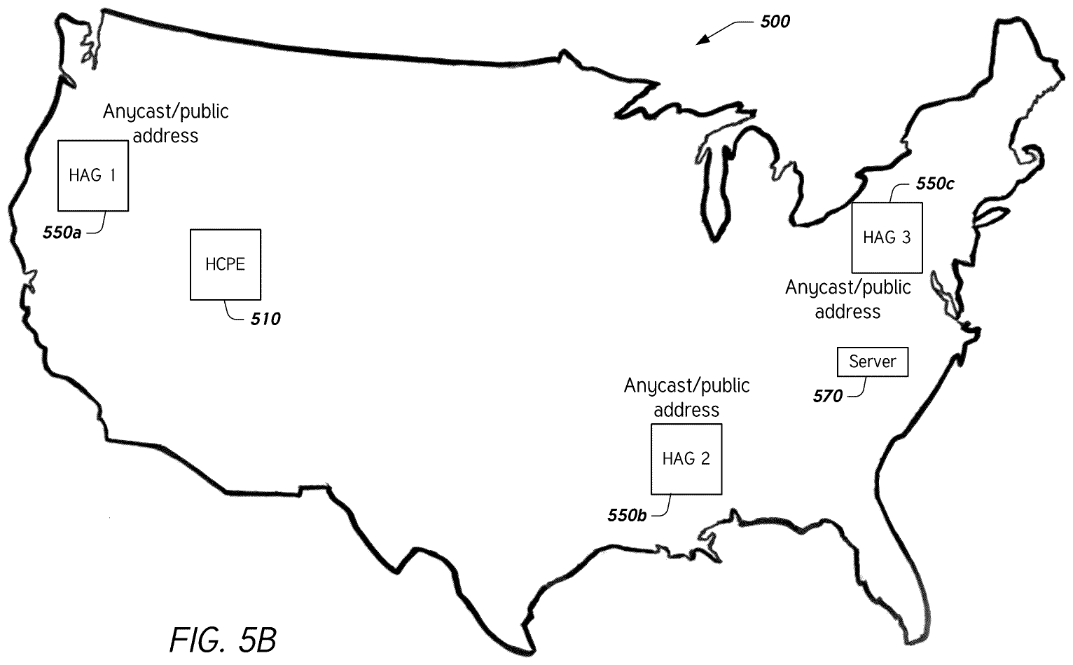

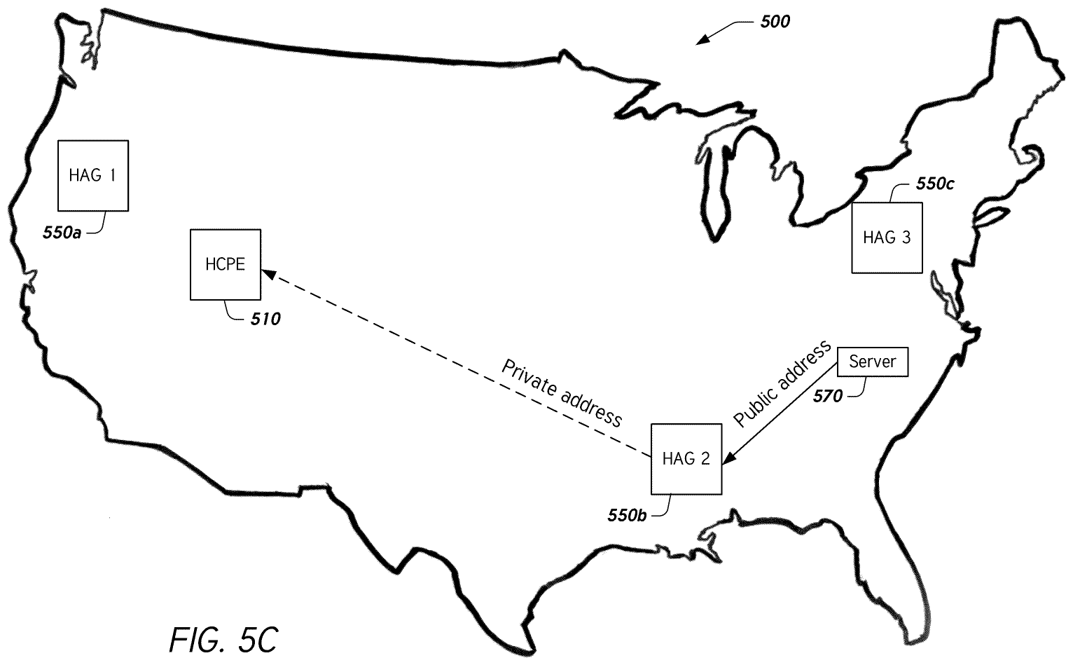

FIGS. 5A, 5B, and 5C illustrate another example network environment 500 to illustrate additional examples of the disclosed procedure for advertising IP anycast addresses to efficiently route network traffic in a hybrid access network. The procedure is performed in a network environment 500 that is similar to the network environments 100, 200, 300, 400 described herein with reference to FIGS. 1-4. The network environment 500 provides connectivity between a HCPE 510 and a network server 570 by way of HAGs 550a-550c. The HCPE 510 is similar to the CPEs described herein with reference to FIGS. 2-4. Similarly, the network server 570 is similar to the network services 170 and the network servers 370, 470 described herein with reference to FIGS. 1, 3 and 4, respectively. The HAGs 550a-550c are similar to the gateways 150, the HAG 250, and the HAGs 350a, 350b, 450a-450d described herein with respect to FIGS. 1-4, respectively.

The network environment 500 provides network communications to the HOPE 510 to enable communication with the network server 570 using a hybrid access network (HAN), where communication over the HAN is illustrated using dashed arrows. The HAN is similar to the hybrid access networks 240a, 240b described herein with reference to FIG. 2. The HAN may incorporate any suitable technology and can include, for example and without limitation, a hybrid network, a satellite network, a VPN, an ISP, etc. Communication with the network server 570 also occurs over a public network, where communication over the public network is illustrated using solid arrows. The public network can be any network external to the HAN and may include the Internet, for example.

FIGS. 5A-5C illustrate a typical network traffic flow employing the disclosed technologies. The network environment 500 illustrates the disclosed process in a geographical setting using a HAN. FIG. 5A illustrates that, in such an environment, a request from a network client (through the HCPE 510) is sent to a first HAG 550a via the HAN using a private network address (e.g., a user IP address). The first HAG 550a can be selected because it is physically the closest HAG to the HCPE 510 or it can be selected because it is the network closest to the HCPE 510, where network closeness is related to the network performance and to the number of network elements on the path. The request can be sent via satellite, a terrestrial network, or a combination of both. The HAG 550a routes the request to the network server 570 over a public network using a public network address (e.g., a public IP address) as a source address. FIG. 5B illustrates that the HAGs 550a-550c advertise the same anycast network address, the anycast network address corresponding to the public network address used as the source address. FIG. 5C illustrates that the public network selects the lowest-cost communication path to the HAG 550b from the network server 570. The HAG 550b forwards the network traffic to the network client over the HAN (using the satellite network and/or the terrestrial network) using the private network address of the network client.

### Example Methods of Advertising Public Addresses at Multiple Gateways

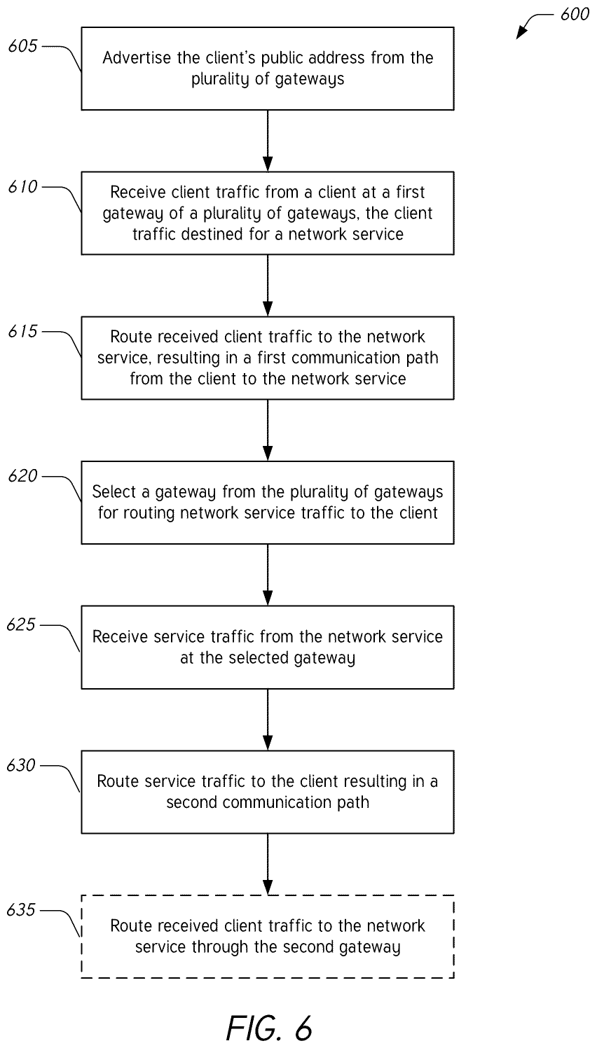

FIG. 6 illustrates an example method 600 of improving network performance by advertising a public network address of a network client at multiple gateways that interface between a private network and a public network. The method 600 can be performed by any component or combination of components of a network environment, such as the network environments described herein with reference to FIGS. 1-5.

At block 605, a plurality of gateways advertises the public network address of the network client. Each of the plurality of gateways acts as an interface between a private network and a public network. The plurality of gateways advertises the public network address at diverse points interfacing between the two networks for presence mapping from a private network to a public network. This presence mapping allows for network traffic from a network service on the public network to be routed to the network client on the private network along an efficient or advantageous path, such as a shortest or lowest cost path (e.g., according to a routing metric). In some embodiments, the shortest or lowest cost path is determined within the public network. In such embodiments, this may improve or degrade network performance (e.g., increase or decrease network latency) between a network client and a selected gateway within the private network.

As disclosed herein, some embodiments of the method 600 may advertise a single public network address at a plurality of gateways, the single public network address corresponding to a plurality of network clients and/or to a plurality of private network addresses. This may be accomplished by managing port mappings based on the traffic flows of network clients.

At block 610, client network traffic is received from a network client at a first gateway of the plurality of gateways, the client network traffic destined for a targeted network service. The first gateway may be selected based on a current policy that selects a default gateway. This can be based at least in part on geographical or physical proximity to the network client and/or it can be based at least in part on network proximity to the network client. In some embodiments, the client network traffic is tunneled to the first gateway via an overlay network.

At block 615, the received network client traffic is routed to the targeted network service, resulting in a first communication path from the network client to the targeted network service. In some embodiments, the first gateway removes encapsulation of the overlay network and sends the network client traffic over an external network to the targeted network service. The departing client network traffic includes the public network address of the network client as the source address.

At block 620, a gateway from the plurality of gateways is selected for routing network service traffic from the targeted network service back to the originating network client. The selected gateway is one of the plurality of gateways advertising the public network address of the network client, as described in block 605. The selected gateway may be selected because it provides a superior communication path relative to the other gateways that advertised the public network address of the network client. Superiority of a communication path may be determined based at least in part on a reduction or minimization of a routing cost and/or a routing distance.

At block 625, the network service traffic is received at the selected gateway. The network service traffic is addressed to the public network address of the network client. At block 630, the network service traffic is routed to the network client resulting in a second communication path. In some embodiments, the second communication path has the same or lower cost (based on some routing metric) relative to the first communication path. In certain embodiments, the portion of the second communication path from the network service to the selected gateway has the same or lower cost relative to the portion of the first communication path from the first gateway to the network service (e.g., the portions of the communication paths within the public network).

In some embodiments, the selected gateway is the same gateway as the first gateway. This may occur where the first communication path represents an acceptable or optimal communication path or where other communication paths are not suitably superior to the first communication path. In such embodiments, the first communication path and the second communication path are the same communication path.

Because the public network address of the network client is now the destination address of the network service traffic, advertising the public network address at a plurality of gateways enables selection of a cost-efficient or optimal communication path to a gateway from the network service. The public network address is advertised at diverse points interfacing between the private and public networks enabling local routing rules to find a lowest cost route and to send the traffic to what local routing logic considers the nearest or lowest cost gateway. This gateway is one that is advertising the public network address of the network client, enabling the public network to effectively pick a gateway nearest (considering physical proximity and/or network proximity) to the destination network service.

Optionally at block 635, further communication with the targeted network service is directed through the selected gateway rather than directing network traffic from the network client to the targeted network service through the default gateway (e.g., the first gateway). In some embodiments, the selected gateway can signal in a way that a CPE coupled to the network client is aware which gateway was selected as the nearest or preferred gateway for the targeted network service. In such embodiments, subsequent packets can be forwarded by the CPE to the gateway nearest to the targeted network service. This may be done by creating a policy entry, directing traffic (either specific to higher level protocol details or general based on the network address) to the gateway identified as closest to the targeted network service. Signaling can include in-band signaling using metadata in the encapsulated returning tunnel packet or out-of-band signaling using a separate packet.

### Additional Embodiments and Terminology

As used herein, the terms network traffic, client traffic, server or service traffic, or traffic flow can be used to refer to a stream of related packets between a network client and a network service. In a TCP or UDP over IP network, this may be identified by a five tuple value of protocol (TCP/UDP), source IP address, destination IP address, source port, and destination port.

As used herein, network addresses include any suitable protocol such as IP addresses. As used herein, network proximity or network closeness can be different from physical proximity or physical closeness and may be related to the number of network elements between two end points (e.g., a network client and a network service). Being network close can mean that two entities have relatively low network latency between them and may or may not be related to physical or geographical closeness.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method of improving network performance by advertising a public network address of a network client at a plurality of gateways in a network, the method comprising:
receiving client network traffic from a network client at a first gateway of a plurality of gateways, the client network traffic destined for a targeted network service, the network client having a private network address and a public network address;
routing the client network traffic to the targeted network service using the public network address of the network client as a source network address, the client network traffic routed from the network client to the targeted network service using a first communication path;
for each of the plurality of gateways in the network, advertising the public network address of the network client on the network;
selecting a gateway from the plurality of gateways for routing service network traffic from the targeted network service to the network client;
receiving service network traffic from the targeted network service at the selected gateway; and
routing the service network traffic to the network client along a second communication path that includes the selected gateway.

2. The method of claim 1, wherein a median route along the portion of the second communication path between the targeted network service and the selected gateway has a cost that is less than or equal to a cost of the portion of the first communication path between the targeted network service and the first gateway.

3. The method of claim 1, wherein the network comprises a satellite network.

4. The method of claim 1, wherein the network comprises a hybrid access network.

5. The method of claim 1 further comprising routing additional network traffic from the network client to the targeted network service using the second communication path.

6. The method of claim 1 further comprising receiving a signal indicating that the second gateway was selected for inclusion in the second communication path.

7. The method of claim 6 further comprising routing packets from the network client to the targeted network service through the second gateway.

8. The method of claim 1, wherein each of the plurality of gateways is a hybrid aggregation gateway.

9. The method of claim 1, wherein the first gateway is network closer to the network client than the second gateway.

10. The method of claim 1, wherein the first gateway is selected based on a default gateway assigned to the network client.

11. A network environment comprising:
customer premises equipment communicatively coupled to a network client, the network client having a private network address;
a private network configured to provide network communication between the network client and a targeted network service on a public network; and
a plurality of gateway devices communicatively coupled to the private network and to the public network, the plurality of gateway devices configured to route network traffic between the private network and the public network, each of the plurality of gateway devices configured to advertise a public network address that corresponds to the network client,
wherein network traffic is routed to the network client from the targeted network service through a selected gateway device of the plurality of gateway devices, the selected gateway device selected based at least in part on the selected gateway device providing a lowest-cost communication path between the targeted network service and the selected gateway.

12. The network environment of claim 11, wherein the private network address and the public network address are each an Internet Protocol (IP) address.

13. The network environment of claim 11, wherein the private network comprises a satellite network.

14. The network environment of claim 11, wherein the private network comprises a hybrid access network.

15. The network environment of claim 11, wherein additional network traffic is routed from the network client to the targeted network service through the selected gateway.

16. The network environment of claim 11, wherein the network client is configured to receive a signal from the selected gateway indicating that the selected gateway was selected to provide a communication path between the network client and the targeted network service.

17. The network environment of claim 16, wherein the network client is configured to route subsequent packets to the targeted network service through the selected gateway.

18. The network environment of claim 11, wherein each of the plurality of gateways is a hybrid aggregation gateway.

19. The network environment of claim 11, wherein a first gateway device of the plurality of gateway devices is configured to provide a first communication path from the network client to the targeted network service, the first gateway device different from the selected gateway device.

20. The network environment of claim 19, wherein the first gateway device is a default gateway assigned to the network client.
